(19) United States
(12) Patent Application Publication
(10) Pub. No.: US 2008/0163043 A1
(43) Pub. Date: Jul. 3, 2008

(54) Method and Apparatus for Data Analysis in a Word Processor Application

(75) Inventors: Paul van Eikeren, Bend, OR (US); Joshua S. van Eikeren, Bend, OR (US)

Correspondence Address: PAUL VAN EIKEREN;BLUE REFERENCE, INC., 2554 NW 1ST ST., BEND, OR, 97701, US

(73) Assignee: Blue Reference, Inc., Bend, OR (US)

(21) Appl. No.: 11/619,343

(22) Filed: Jan. 3, 2007

(51) Int. Cl. G06F 3/048; G06F 17/00; G06F 17/20; G06F 17/21; G06F 17/22; G06F 17/24; G06F 17/25; G06F 17/26; G06F 17/27; G06F 17/28

(52) U.S. Cl. 715/255

(57) ABSTRACT

A computer-implemented method for generating data-analysis results in a word processing program is disclosed. The method may entail the following: providing a data-analysis template, wherein the data-analysis template comprises a word processor document comprising a data-analysis parts container; including at least one data-analysis part in the data-analysis parts container; communicating the data-analysis parts container to a data-analysis processor for generating a data-analysis results collection using the data-analysis parts container; and generating a data-analysis results document.

### CROSS-REFERENCE TO RELATED APPLICATIONS

U.S. patent application Attorney Docket No. BLUEREF-001, filed on Jan. 3, 2007 and entitled “Method and Apparatus for Utilizing an Extensible Markup Language Data Structure For Defining a Data-Analysis Parts Container For Use in a Word Processor Application,” U.S. patent application Attorney Docket No. BLUEREF-002, filed on Jan. 3, 2007 and entitled “Method and Apparatus for Managing Data-Analysis Parts in a Word Processor Application,” and U.S. patent application Attorney Docket No. BLUEREF-003, filed on Jan. 3, 2007 and entitled “Object-Oriented Framework for Data-Analysis Having Pluggable Platform Runtimes and Export Services,” which are assigned to the same assignee as the present invention, are hereby incorporated, in their entirety, by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the United States Patent and Trademarks Office patent or records, but otherwise reserves all copyright rights whatsoever.

### BACKGROUND

Data analysis is a process involving the organization, examination, display, and analysis of collected data using narratives, figures, structures, charts, graphs and tables. Data analyses are aided by data-analysis processor, which are computational engines, either in hardware or software, which can execute the data analysis process. High-end data-analysis processor typically have a language component like the R, S, SAS, Mathlab®, Python, and Perl families of languages. The availability of a language component facilitates data analysis in numerous ways including the following: providing arbitrary data transformations; applying one analysis result to results form another; abstraction of repeated complex analysis steps; and development of new methodology.

A principal challenge in using data-analysis processors is communicating the results of data analysis to data owners. Generation of reports as part of a data analysis project typically employs two separate steps. First, the data are analyzed using a data-analysis application based on a data analysis processor. And two, data analysis results (tables, graphs, figures) are used as the basis for a report document using a word processor application. Although, many data analysis applications try to support this process by generating pre-formatted tables, graphs and figures that can be easily integrated into a report document using copy-and-paste from the data analysis application to the word processor application, the basic paradigm is to construct the report document around the results obtained from data analysis.

Another approach for integration of data analysis and report document generation is to embed the data analysis itself into the report document. The concept of “literate programming systems”, “literate statistical practice” and “literate data analysis” are big efforts in this area. Proponents of this approach advocate software systems for authoring and distributing these dynamic data-analysis documents that contain text, code, data, and any auxiliary content needed to recreate the computations. The documents are dynamic in that the contents, including figures, tables, etc., can be recalculated each time a view of the document is generated. The advantage of this integration is that it allows readers to both verify and adapt the data analysis process outlined in the document. A user can readily reproduce the data analysis at any time in the future and a user can present the data analysis results in a different medium. Accordingly, a need exists for computer-implemented applications, methods and systems that enable users to integrate data analysis and data-analysis results generation using familiar software applications like a word processor application.

Whatever the precise merits and features of the prior art in this field, the earlier art does not achieve or fulfill the purposes of the present invention. The prior art does not provide for the following:
the capability to perform word processing and data analysis within a single integrated environment;
the capability of an integrated container for holding a plurality of data-analysis parts and data-analysis part types in an electronic document for maintaining all data-analysis parts in one place;
the capability of using a data-analysis template for generating standardized formats for data-analysis results documents in a word processor application;
the capability of using a WYSIWYG word processor for generating data-analysis results documents thereby eliminating the need to learn complex text formatting languages;
the capability to select from a plurality of pluggable data-analysis processors for generating a data-analysis results document within a word processor application; and
the capability to generate data-analysis results documents in a word processor application for further editing, for saving in plurality of file formats, and for saving in a document management system.

### SUMMARY

A computer-implemented method for generating data-analysis results in a word processor application is disclosed. The method may entail providing a data-analysis template wherein the data-analysis template comprises a word processor document and a data-analysis parts container, including at least one data-analysis part in the data-analysis container, communicating the data-analysis parts container to a data-analysis processor for generating a data-analysis results collection using the data-analysis parts container, and generating a data analysis results document.

The method may entail the following: using a word processor document comprising a data structure wherein presentation content and data content may be separated; using a word processor document comprising a Microsoft Word document; using a data-analysis parts container comprising an extensible markup language data structure; using at least one data-analysis part selected from a group comprising an object, a code block and an expression; using a data-analysis processor comprising one or more of the following: a language interpreter, a library of methods, and a runtime environment; using a data-analysis processor selected from a group of data-analysis processors; using a data-analysis processor provided by the local machine, a network server or a web service; generating a data-analysis results document comprising a word processor document comprising information from the data-analysis template and information from the data-analysis results collection.

The method may further entail the following: storing the data-analysis document as an electronic document file; storing the data-analysis document file in a format selected from a list of file formats; modifying the data-analysis results document; editing the data-analysis template; generating the data-analysis template; managing the data-analysis template in an electronic document management system; and managing the data-analysis results document in a electronic document management system.

The method may also operate on a computer readable medium having computer readable information or a computing apparatus.

### BRIEF DESCRIPTION OF THE DRAWINGS

FIG.1 is a block diagram of a computing apparatus that may operate in one exemplary embodiment of the present invention;

FIG. 2A is a flowchart of a method in accordance with the claims;

FIG. 2B is a block diagram illustrating the interaction of the elements of the method in accordance with the claims;

FIG. 3 is an illustration of an exemplary embodiment of a data-analysis template;

FIG. 4 is an illustration of an exemplary embodiment of a data-analysis template after modification;

FIG. 5 is an illustration of an exemplary embodiment of linking between the data-analysis template and an actions pane;

FIG. 6 is an illustration of an exemplary embodiment of a printout of a data-analysis results document;

FIG. 7 is an illustration of an exemplary embodiment of editing a data-analysis part in a data-analysis template; and

FIG. 8 is an illustration of an exemplary embodiment of inserting a data-analysis part in a data-analysis template.

DEFINITION LIST

| Term | Definition |
|---|---|
| action pane | As used herein, the term “action pane” refers to a sectioned |
| | region in a graphical computer display, which may be used to |
| | enter, select or display actions to be performed by the |
| | applications program. Also, sometimes referred to as a “task |
| | pane.” |
| code block | As used herein, the term “code block” refers to a logical |
| | grouping of computer-readable instructions comprising one |
| | or more lines of programming code, which may contained in |
| | a data-analysis parts container and which may be executed |
| | by a data-analysis processor. |
| data analysis | As used herein, the term “data analysis” refers to the process |
| | of collecting, organizing, examining, displaying and |
| | analyzing collected data using narratives, charts, graphs, |
| | figures, structures or tables. Data analysis might include the |
| | following: processing data in order to draw inferences and |
| | conclusions; systematically applying statistical and logical |
| | techniques to describe, summarize, and compare data; and |
| | systematically studying the data so that its meaning, |
| | structure, relationships, origins and other properties are |
| | understood. |
| data set | As used herein, the term “data set” refers to a computer- |
| | readable collection of related data organized and structured |
| | according to one or more defined data structures including, |
| | but not limited to the following: vector, array, matrix, list, |
| | data frame, tuple, table, record, tree and graph. Data sets |
| | may be serialized, for example, to text documents in |
| | conformance to well-defined formats such as StatDataML, an |
| | XML format for statistical data, and to binary formats. |
| data-analysis part | As used herein, the term “data-analysis part” refers to a |
| | computer-readable component entity involved in data |
| | analysis including but not limited to the following: data sets, |
| | formulas, algorithms, models, code blocks, expressions, code |
| | libraries, scripts, instructions, software objects, files, dynamic |
| | and static libraries, packages, statistical components, |
| | simulation components, graphing components, database |
| | components, files, and records. |
| data-analysis parts container | As used herein, the term “data-analysis part container” refers |
| | to a computer-readable container entity, such as an object |
| | that holds other objects, for holding one or more data- |
| | analysis parts. |
| data-analysis processor | The term “data analysis processor” refers to a computational |
| | engine for performing data-analysis on a data-analysis |
| | container for generating a data-analysis results collection. A |
| | data-analysis processor may be implemented via a data- |
| | analysis object-oriented framework comprising a collection |
| | of co-operating components implemented in hardware or |
| | software. A data-analysis processor may include a dynamic |
| | programming language, a library of methods, or a runtime |
| | with an application programming interface. |
| data-analysis template | As used herein, the term “data-analysis template” refers to a |
| | computer-readable data structure comprising of a word |
| | processor document and a data-analysis parts container, |
| | where the template may serve as a master or pattern for the |
| | generation of a data-analysis results collection and/or a |
| | data-analysis results document. Data-analysis templates |
| | allow the data-analysis results collection and the data- |
| | analysis results document to have content which is structured |
| | and formatted in standardized and recognizable ways. |
| document | As used herein, the term “document” refers to a computer- |
| | readable document object entity, which may be structured as |
| | a document object model. A document is instantiated in a |
| | word processor application and may be serialized, for |
| | example, to a web page for viewing, to a disk for storage as a |
| | file or to a printer for hard copy. |
| document management system | As used herein, the term “document management system” |
| | refers to a computer system and/or application programs |
| | used to track and store electronic documents. Document |
| | management systems commonly provide storage, versioning, |
| | metadata, security, indexing, searching and retrieval |
| | capabilities for electronic documents. |
| electronic document | As used herein, the term “electronic document” refers to any |
| | computer data, other than program or system files, which are |
| | intended to be used in the digital form, without requiring |
| | (although they may be) that they be first printed. |
| markup language | As used herein, the term “markup language” (“ML”) refers to a |
| | language of special codes within a document that specify how |
| | parts of the document are to be interpreted by an application. |
| | In a word processor file, the markup language may specify |
| | how the text is to be formatted or laid out. |
| object | As used herein, the term “object” is a principal building block |
| | in object-oriented design or programming. It refers to a |
| | computer-readable concrete realization, an instance, of a |
| | class that consists of data and the operations associated with |
| | that data. |
| word processor | As used herein, the term “word processor application” refers |
| | to a computer application operative to provide functionality |
| | for creating, displaying, editing, formatting and printing |
| | electronic documents. |

### DETAILED DESCRIPTION

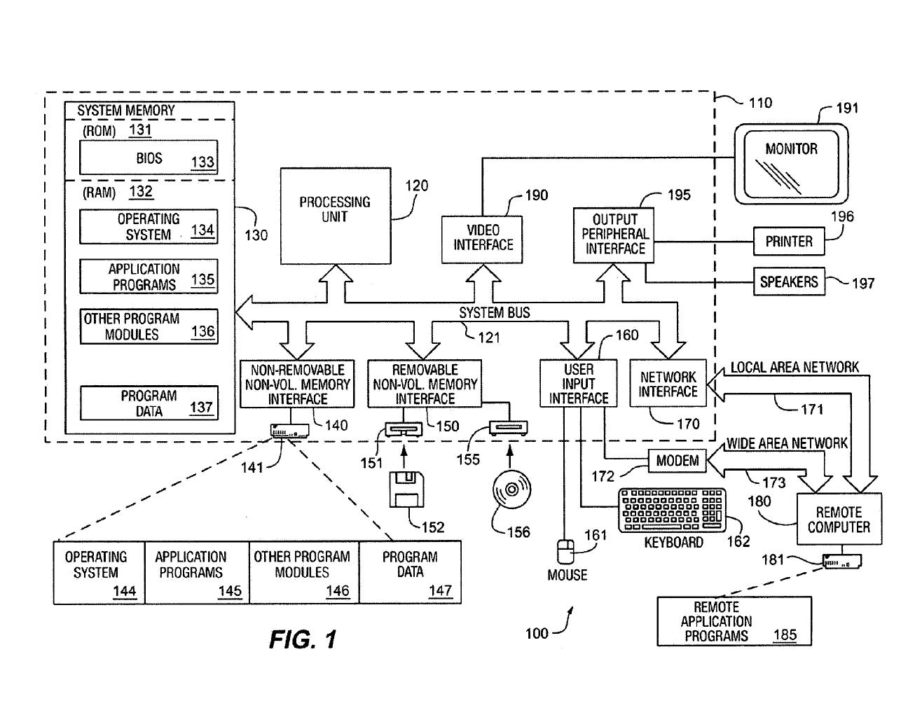

Referring now to the drawings, in which like numerals represent like elements through several figures, aspects of the present invention and the exemplary operating environment will be described. FIG. 1 illustrates an example of a suitable computing system environment 100 on which a system for the steps of the claimed method and apparatus may be implemented. The computing system environment 100 is only one example of a suitable computing environment and is not intended to suggest any limitation as to the scope of use or functionality of the method of apparatus of the claims. Neither should the computing environment 100 be interpreted as having any dependency or requirement relating to any one or combination of components illustrated in the exemplary operating environment 100.

The steps of the claimed method and apparatus are operational with numerous other general purpose or special purpose computing system environments or configurations. Examples of well known computing systems, environments, and/or configurations that may be suitable for use with the methods or apparatus of the claims include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The steps of the claimed method and apparatus may be described in the general context of computer-executable instructions, such as program modules, being executed by a computer. Generally, program modules include routines, programs, objects, components, data structures, and other computer instructions or components that perform particular tasks or implement particular abstract data types. The methods and apparatus may also be practiced in distributed computing environments where tasks are performed by remote processing devices that are linked through a communications network, such as web services. In a distributed computing environment, program modules may be located in both local and remote computer storage media including memory storage devices.

With reference to FIG. 1, an exemplary system for implementing the steps of the claimed method and apparatus includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates the following: operating system 134, such as the WINDOWS XP operating system from Microsoft Corporation of Redmond, Wash.; application programs 135, such as the word processor Word developed by Microsoft Corporation; other program modules 136, such as data-analysis processors including R from the R-PROJECT, S-Plus from INSIGHTFUL CORPORATION, PYTHON from the PYTHON SOFTWARE FOUNDATION, MATLAB from MATHWORKS CORPORATION, and PERL from the PERL FOUNDATION; and program data 137, such as a data-analysis template comprising a word processor document, for example in the form of a WORD word processor program document and a data-analysis parts container. It should further be appreciated that the various aspects of the present invention are not limited to word processing applications programs but may also utilize other application programs 135 which are capable of processing data-analysis parts, such as spreadsheet (e.g., EXCEL spreadsheet program from MICROSOFT CORPORATION) and presentation (e.g., POWERPOINT presentation program from MICROSOFT CORPORATION) application programs.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

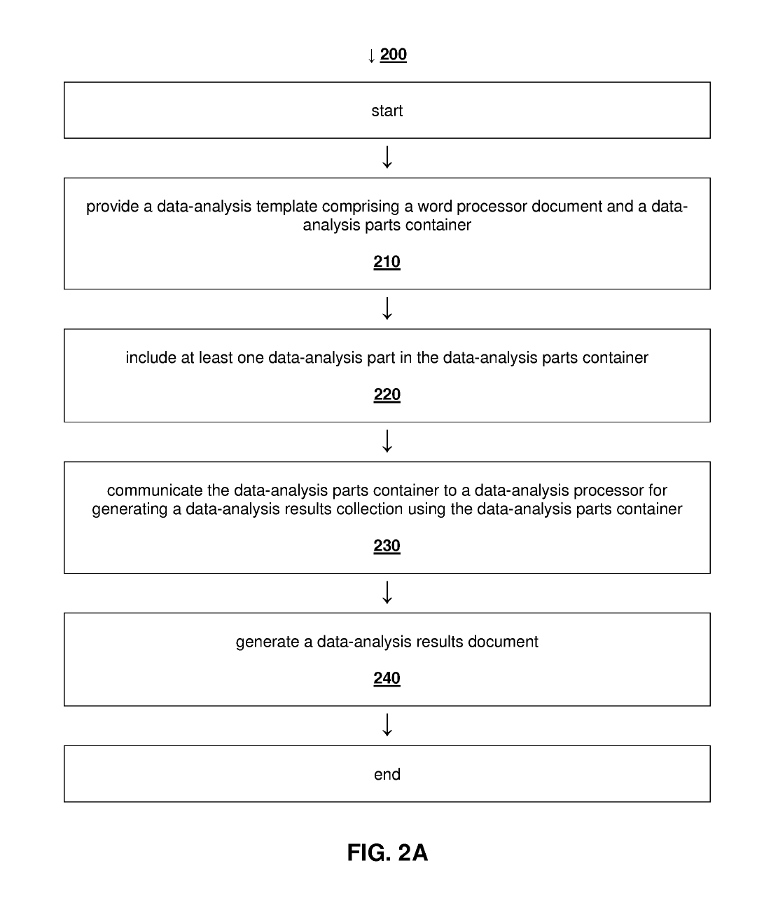

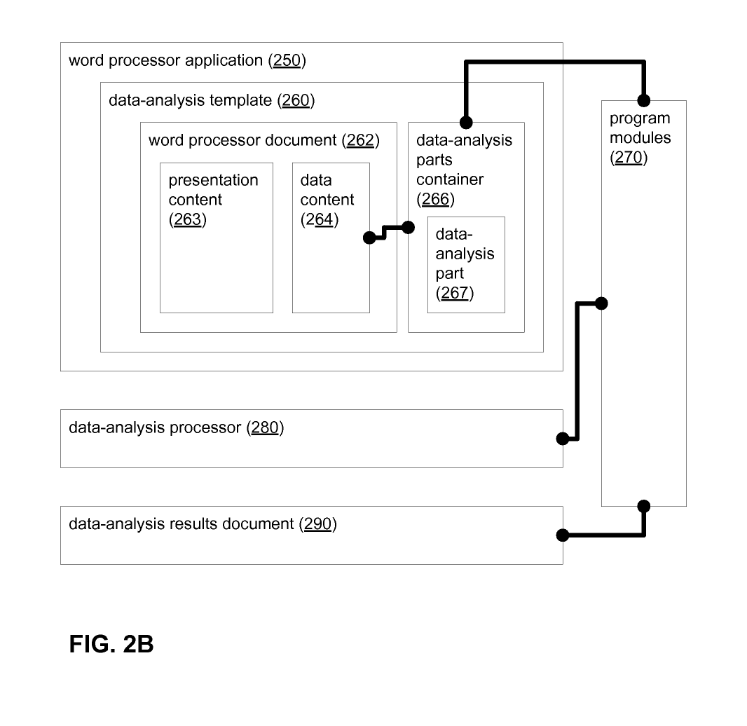

FIG. 2A is an illustration of a routine of steps that may be performed in accordance with the present invention. It should be appreciated that although the embodiments of the invention described herein are presented in the context of the word processor application Word developed by Microsoft Corporation, the invention may be utilized within other application programs including but not limited to other word processing application programs such as StarOffice Writer developed by Sun Microsystems Corporation (also distributed as the Open Source project Open Office), spreadsheet application programs such as Excel developed by Microsoft Corporation, presentation application programs such as PowerPoint developed by Microsoft Corporation, drawing application programs such as Visio developed by Microsoft Corporation, or database application programs such as Access developed by Microsoft Corporation.

When reading the discussion of the routines presented herein, it should be appreciated that the logical operations of the various embodiments of the present invention are implemented as (1) computer-executable instructions, such as program modules, being executed by a computer and/or (2) as interconnected machine logic circuits or circuit modules within the computing system. The implementation is a matter of choice dependent on performance requirements of the computing system implementing the invention. Accordingly, the logical operation illustrated in FIG. 2A, and making up an embodiments of the present invention described herein are referred to variously as operations, structural devices, acts or program modules. It will be recognized by one skilled in the art that these operations, structural devices, acts and modules may be implemented in software, firmware, in special purpose digital logic, and any combination thereof without deviating from the spirit and scope of the present invention as recited within the claims set forth herein.

Referring now to FIG. 2A, the routine 200 starts at operation 210, wherein the method entails providing a data-analysis template, wherein the data-analysis template comprises a word processor document and a data analysis parts container. FIG. 2B shows a block diagram illustrating the relationship among the elements of the method. FIG. 2B shows the logical relationships between the data-analysis parts container 266, the word processor document 262 and the data-analysis template 260. A preferred embodiment of the invention entails a word processor document 262 wherein the presentation content 263 and the data content 264 may be separated. Word processor applications like Word developed by Microsoft Corporation and StarOffice Writer developed by Sun Microsystems Corporation, for example, employ XML data structures for storing the word processor file, which allows separation of the presentation content and the data content. The data-analysis parts container 266 may be embedded in the data content 264 of the word processor document 262, for example as a text string or binary encoded, or it may be maintained as a separate entity and linked to the data content by referencing. Such a data-analysis parts container may hold a variety of data-analysis parts including but not limited to data sets, objects, code blocks and expressions. Further details on the elements of the data-analysis template are described in co-pending U.S. patent application entitled “Method and Apparatus for Utilizing an Extensible Markup Language Data Structure to Define a Data-Analysis Parts Container for Use in a Word Processor Application”, the disclosure of which is incorporated herein, in its entirety, by reference.

Illustrative data-analysis templates for generating data-analysis results include but are not limited to the following: data-analysis templates for assembly as electronic laboratory notebooks (for example: templates in chemistry discovery, biology discovery, chemical development, bioprocess development, formulation development, analytical development and clinical development); data-analysis templates for life sciences (for example: genomic analysis, microarray analysis, Taqman analysis, cheminformatics analysis, clinical trial design and analysis, biostatics analysis, health services and outcomes analysis, process analytical technology analysis); data-analysis templates for economics and finance (for example: loan portfolio valuation analysis, portfolio optimization analysis, risk management analysis, trading strategies analysis, consumer behavior analysis); data-analysis templates for manufacturing (for example: design and analysis of experiments, reliability and life expectancy analysis, field failure analysis, supply chain optimization analysis, demand forecasting optimization analysis, statistical process control analysis, six sigma analysis); and data-analysis templates for business performance analysis (for example: customer churn analysis, fraud detection analysis, data quality management analysis, marketing campaign analysis, customer behavior analysis).

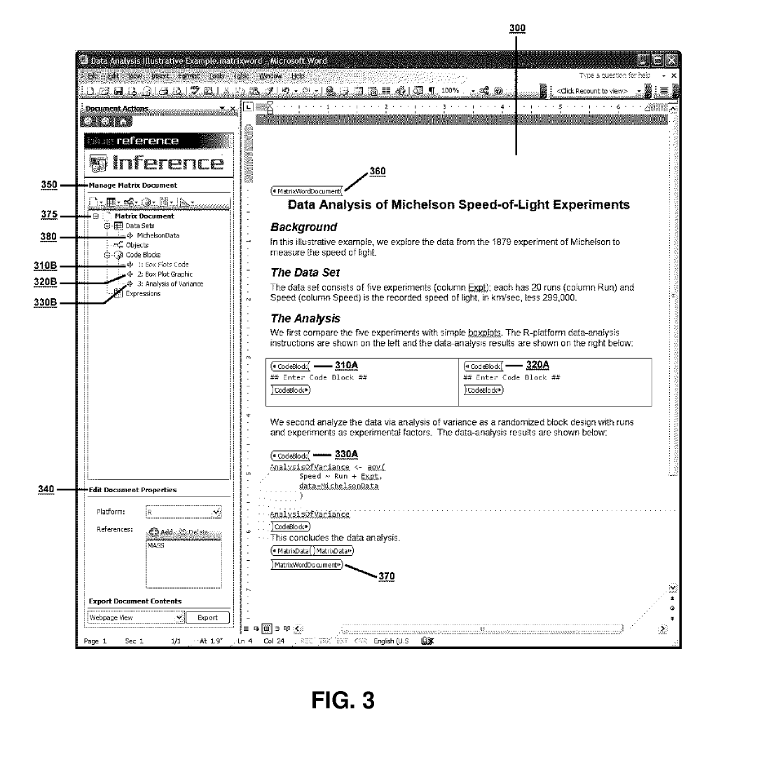

The routine 200 continues from operation 210 to operation 220, wherein the method entails including at least one data-analysis part in the data analysis parts container. FIG. 3 provides an illustrative example of a data-analysis template 300 in a word processor application containing a data-analysis part container with start and end regions defined by the labels MatrixWordDocument 360 and 370, respectively. The data-analysis template may contain document properties 340 including an association with a data-analysis processor labeled “R” and a package reference labeled “MASS.” The illustrative data-analysis template 300 may contain data-analysis parts including but not limited to the following: an empty code block 310A labeled “Box Plots Code” 310B; an empty code block 320A labeled “Box Plot Graphic” 320B; and a filled code block 330A labeled “Analysis of variance” 330B. Additionally, the data-analysis template may contain a data set within the “matrix document” 375 labeled “MichelsonData” 380. Empty code blocks may be placeholders for the insertion of instructions to be communicated to a data-analysis processor; filled code blocks may contain instructions to be communicated to the data-analysis processor; and data sets may contain data which may also be communicated to the data-analysis processor. It should be understood that any text entries outside the boundaries of data-analysis parts may be added to, modified, formatted, or deleted in the standard manner that text is typically managed in a word processor application. Further detailed descriptions and illustrations of including at least one data-analysis part in the data-analysis parts container are contained in the co-pending U.S. patent application entitled “Method and Apparatus for Managing Data-Analysis Parts in a Word Processor Application,” the disclosure of which is incorporated herein, in its entirety, by reference.

Management and retrieval of the data-analysis container and its included data-analysis parts may be achieved by the use of program modules 270. Implementation of such program modules may be through the use of smart document technology, which provides an architecture to build context-sensitive data-analysis templates. Smart document solutions associate an electronic document like a word processor document 262 with an XML schema, so that presentation content 263 like a paragraph of text may be distinguished from data content 264 like a string of text corresponding to a data-analysis parts container 266. It is important to note that the base functionality of the word processor application is retained in a smart document solution. Smart document solutions allows programmatic customization for searching within and operating on extensible markup language (XML) nodes within a data-analysis template, which is comprised of a data-analysis parts container. Data-analysis templates may be documents in a word processor application or may be files that can be opened by a word processor application such as Word developed by Microsoft Corporation.

Smart document solutions may be created using many modern programming systems such as Microsoft Visual Basic™ 6.0, Microsoft Visual Basic .NET™, Microsoft Visual C#™.NET, Microsoft Visual J#™ or Microsoft Visual C++™ development systems. Creation of smart document solutions may be assisted by use of software development tools such as Visual Studio Tools for Office developed by Microsoft Corporation. Smart document solutions may be deployed over a corporate intranet, over the Internet, or through Web sites. Further descriptions and details for the creation of smart document solutions may be found in the book by Eric Carter and Eric Lippert entitled “Visual Studio Tools for Office: Using C# with Excel, Word, Outlook, and Infopath,” Addison Wesley Professional, Microsoft .NET Development Series, 2006.

A user may create a smart document solution as a dynamic linked library (DLL) or as an XML file. An example of the data-analysis template development cycle using the DLL approach may be as follows:
1. Create an XML data structure for a data-analysis parts container. Such a data structure comprises an XML file that may be created using an XML editor such as XML Spy developed by Altova Corporation or a text editor such as Notepad developed by Microsoft Corporation. The XML data structure may be defined by an XML schema. Details on the creation of the XML data structure for the data-analysis container are described in co-pending U.S. patent application entitled “Method and Apparatus for Utilizing an Extensible Markup Language Data Structure to Define a Data-Analysis Parts Container for Use in a Word Processor Application,” the disclosure of which is incorporated herein, in its entirety by reference.
2. Attach the XML data structure for the data-analysis parts container to a word processor document. Associate XML elements with the portions of the document that will have smart document actions associated with them. The result is a data-analysis template. Note that the data-analysis template may be comprised of at least one word processor file or a plurality of word processor files, optionally in a compressed format. A data-analysis template may be stored in a variety of possible file formats including but not limited to the following: standard binary Word (*.doc); extensible markup language file (*.xml); Word document template (*.dot); Word markup language (*.docx); Word markup language macro-enabled document (*.docm); Word markup language document template (*.dotx); and Word markup language macro-enabled document template (*.dotm).
3. Use the smart document API to write code that displays controls in the Document Actions task pane. Write code that takes action when the user interacts with the controls. A preferred embodiment of the present invention employs an object-oriented framework of reusable objects to simplify writing this code and reduce the amount of code that has to be written. The details of this object-oriented oriented framework are described in co-pending U.S. patent application entitled “Object-Oriented Framework for Data-Analysis Having Pluggable Platform Runtimes and Export Services,” the disclosure of which is incorporated herein, in its entirety.
4. Store the smart document code and all of the files used by the smart document on a local machine, on a file server or on a Web server such that a users can access it.
5. Create an XML expansion pack manifest file that references all of the files used by the smart document solution. This step is not required when using Visual Studio Tools for Office.
6. Use the user interface to reference the XML expansion pack manifest file and attach the solution to the document. This step is also not required when using Visual Studio Tools for Office.
7. Distribute the document as a data-analysis template. When a user opens the data-analysis template in the word processor application, the data-analysis template and any supporting files used by the data-analysis template may be used locally or downloaded and registered locally on the user's computer without any user intervention

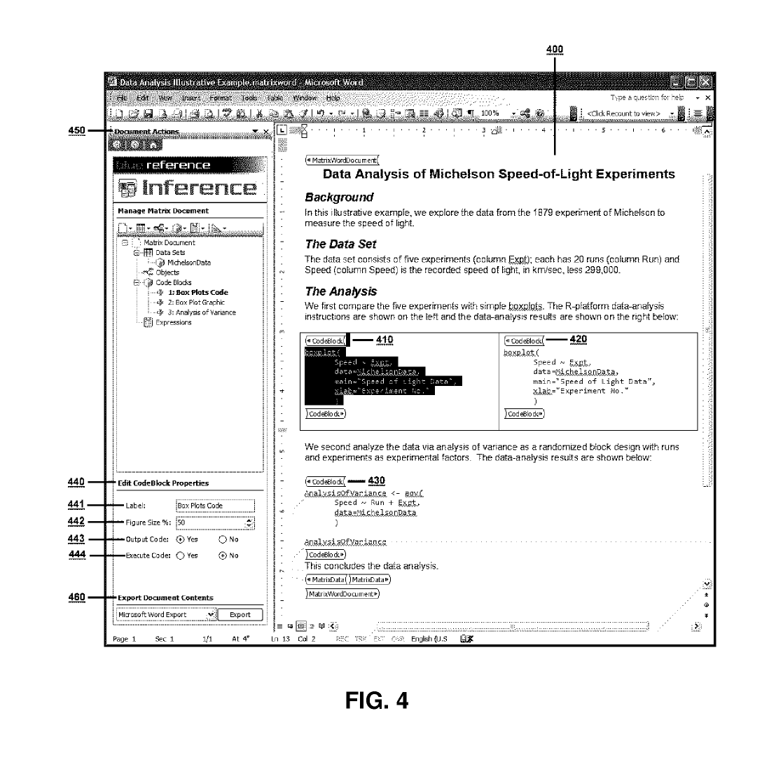

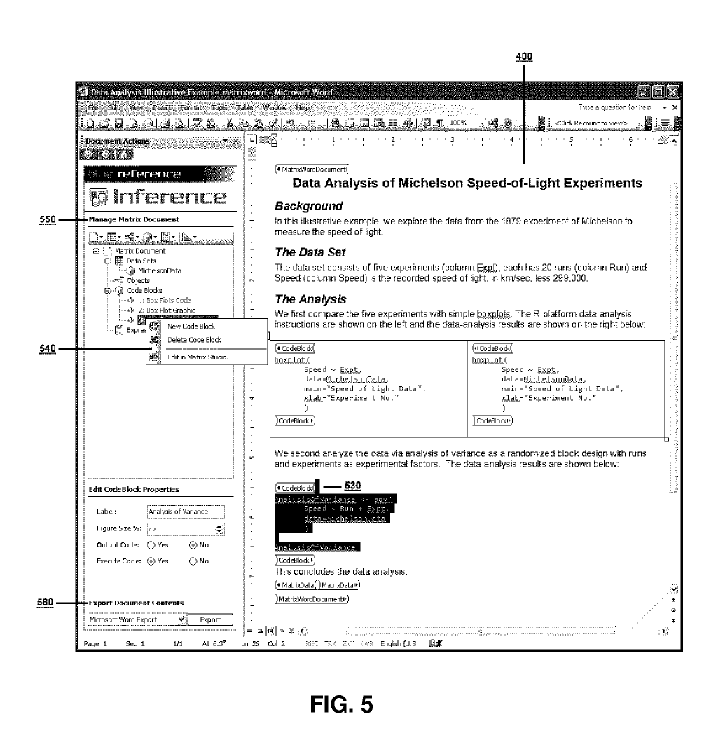

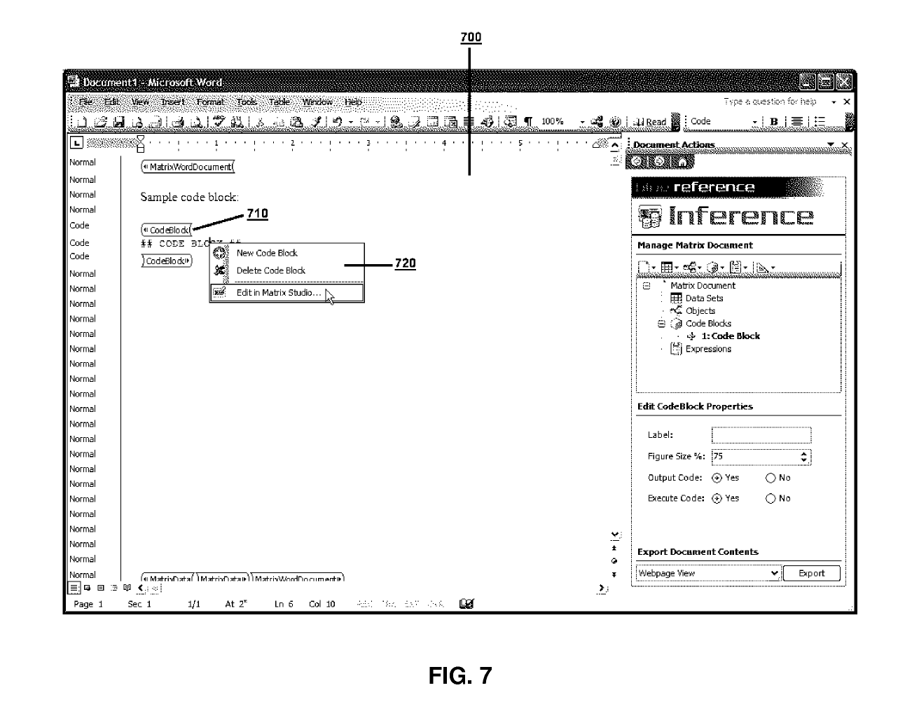

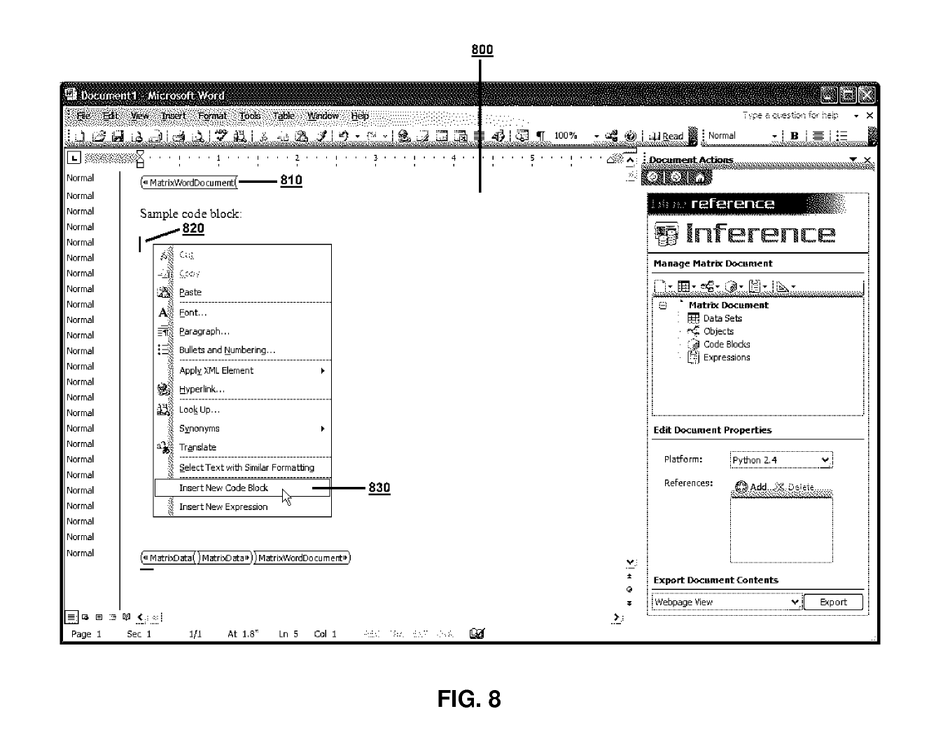

Including at least one data analysis part in the data-analysis parts container may performed in a variety of ways including but not limited to the following: include the data-analysis part in the data-analysis template; modify a data-analysis part included in the data-analysis template; and insert a data-analysis part into an empty data-analysis template. FIG. 4 illustrates the results of modifying data-analysis template 300 to data-analysis template 400 including inserting data analysis instructions in the code block 410 in the computer language of the data-analysis processor associated with the data-analysis template, which in this case is the R processor. FIG. 4 also shows that by selecting CodeBlock 410 a user may modify the properties of the CodeBlock including the following: label 441 (“Box Plot Code”) for identifying the code block; figure size 442 for setting the size of the graphic resulting from execution of the code block after communication to the data-analysis processor; Output Code 443 for setting the code block property which determines whether display of CodeBlock code is suppressed in the data analysis results; and Execute Code 444 for setting the code block property which determines whether execution of the CodeBlock code is suppressed after communication to the data-analysis processor. In addition, selection of data-analysis parts in the data-analysis template may be linked with selection of data-analysis parts in the Document Actions task pane. For example, FIG. 5 shows that selection of a CodeBlock 430 in data-analysis template 400 is linked with selection of a corresponding region in the tree display in Document Actions task pane 450. A user may “right click” on said selection and bring up a menu which allows the user to initiate new actions on data-analysis parts including inserting a new code block, deleting the selected code block or editing the code block in an auxiliary application program. FIG. 5 illustrates that the present embodiment may provide linking between the data-analysis template 400 in a word processor application and a separate auxiliary application program, such as Matrix Studio 540 shown in FIG. 5, which serves as an integrated development environment for generation of data-analysis parts. FIG. 5 also illustrates that selecting a code block, for example 530, selects the linked data-analysis part, for example CodeBlock with Label “Analysis of Variance” in the action pane 550, which may raise an event that brings up a menu, for example menu 540, which allows the user to edit the code block in an auxiliary application program such as “Edit in Matrix Studio”. FIG. 7 illustrates an exemplary embodiment of the invention which may allow the user to select a data-analysis part, such as a code block 710, in a data-analysis template 700 in a word process application and bring up (“right click”) a menu 720, which allows the user to select editing actions. FIG. 8 illustrates another exemplary embodiment of the invention which may allow the user to place the cursor 820 in a data-analysis template 800 in a word processor application and bring up (“right click”) a menu, which allows the user to insert a new code block 830.

The routine 200 continues from operation 220 to operation 230, wherein the method entails communicating the data-analysis parts container to a data-analysis processor 280 for generating a data-analysis results collection using the data-analysis parts container. The data-analysis results collection may comprise a collection of computer-readable objects, a collection of serialized objects such as disk files, or a combination of both. Initiating communication is illustrated in FIG. 5 by selection of the Export Document Contents 560 function after selecting a suitable choice of export format. By this action, the data analysis parts container is communicated to the data-analysis processor associated with the data-analysis template. Communication of the data-analysis container to the data-analysis processor may be accomplished by using program modules 270. Those skilled in the art will recognize that program modules may operate with data-analysis processors through various means including their language interpreters, libraries of methods and runtime environments. Illustrative data-analysis processors suitable for use with embodiments of the present invention include but are not limited to the following: R processor developed by R-Project for Statistical Computing; S-Plus™ processor developed by Insightful Corporation; MATLAB™ processor developed by MathWorks Corporation; Python processor developed by Python Foundation; Ironpython processor developed by Microsoft Corporation; Perl processor developed by Perl Foundation; SAS™ processor developed by SAS Institute Corporation; Mathematica™ processor developed by Wolfram Research Corporation; Octave processor developed by the University of Wisconsin; F# processor developed by Microsoft Corporation; Haskell processor developed by Yale Haskell Group; and Ruby processor developed by Gardens Point. Embodiments of the inventions allow providing a data-analysis processor in a variety of ways including but not limited to the following: installation on a local machine; installation on a network server; and as a web service.

Construction of program modules for communication of the data-analysis parts container with the data-analysis processor and for generation of the data-analysis results document may be aided by the use of an object-orient framework of cooperating components. Such a framework and its use is described in co-pending U.S. patent application entitled “Object-Oriented Framework for Data-Analysis Having Pluggable Platform Runtimes and Export Services,” the disclosure of which is incorporated herein, in its entirety.

The routine 200 continues from operation 230 to operation 240, wherein the method entails generating a data-analysis results document 290. In one embodiment, the data-analysis results document comprises a word processor document comprising information from the data-analysis template and information from the data-analysis results collection. In such an embodiment, a data-analysis results collection of objects is returned by the data-analysis processor and merged with presentation content from the word processor document to generate a data-analysis results document in accordance with the specifications of the data-analysis template. The routine 200 then ends.

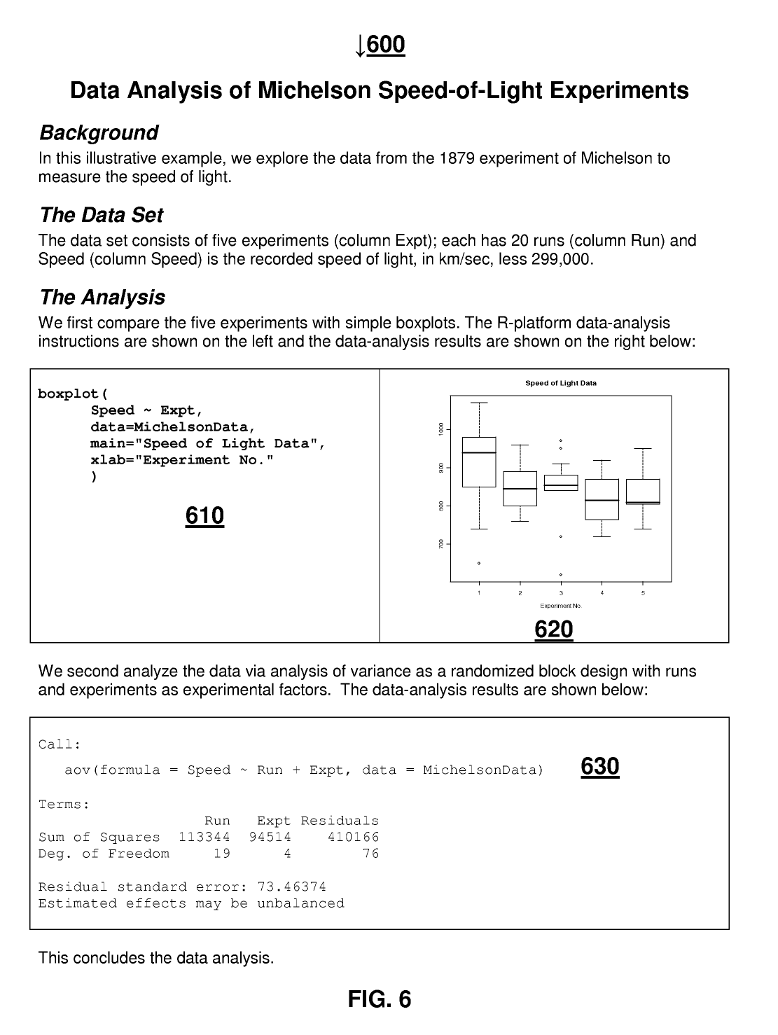

FIG. 6 is an illustrative example of the printout of a data-analysis results document 600 obtained by the application of the routine in FIG. 2. Illustrated in FIG. 4, “Export the Document Contents” action to “Microsoft Word Export” 460 is applied to the data-analysis template 400 and followed by communication to a printer to yield FIG. 6. Additionally, FIG. 6 illustrates that execution of the routine in FIG. 2 provides the following: the instructions of code block 410 may be displayed 443 but not executed; the instructions of code block 420 may have their display suppressed but the graphic results of execution displayed; and the instructions of code block 430 may have their display suppressed but the text results of execution displayed. It is important to recognize that FIG. 6 illustrates only one of many possible electronic document and corresponding electronic document files outputted from “Export Document Contents” action 460. For example, possible outputted documents may include but are not limited to the following: printed pages; graphic files; word processing document files; portable document files; extensible markup language files; text files; and hypertext markup files.

Again referring to FIG. 6, the resulting document in the word processor application may be stored as a word processing document. For example, if the word processor application was Word developed by Microsoft Corporation, the document may be saved in a range of file formats including but not limited to the following: portable document format (*.pdf); binary Word (*.doc); XML paper specification format (*.xps); extensible markup language file (*.xml); Word document template (*.dot); single file web page (*.mht, *.mhtml); web page (*.htm, *.html); web page, filtered (*.htm, *.html); rich text format (*.rtf); plain text (*.txt); Word markup language (*.docx); Word markup language macro-enabled document (*.docm); Word markup language document template (*.dotx); Word markup language macro-enabled document template (*.dotm); and LaTeX format (*.tex). It should be noted that Word markup language format is also referred to as Wordprocessing markup language or Microsoft Office Word 2003 XML Reference Schemas. In addition, the user may be allowed to modify the word processing document or subjected to further processing. For example, if the user desired to annotate the data analysis results document at the bottom of FIG. 6, the user may be permitted to simply type the annotation in the document.

A user may be able to store the data-analysis results document files resulting from “Export Document Contents” action 560 to an electronic document management system (EDMS). It should be understood that an embodiment of the present invention may serve as a knowledge management system for applications including but not limited to the following: an electronic laboratory notebook (ELN) system; an electronic data analysis notebook (EDAN) system; and a laboratory information management (LIMS) systems. An EDMS is a computer system or set of computer programs used to track and store electronic documents, like those in the embodiments of the present invention. An EDMS commonly provides storage, versioning, metadata, security, indexing, and retrieval capabilities. Also, an EDMS may provide workflow and collaboration capabilities. For example, if the word processor application used in an embodiment of the present invention is Word developed by Microsoft Corporation, a user may export and store word processing documents in a Document Workspace, a shared workspace which is part of Microsoft Windows SharePoint Services site. Within such a shared workspace a user may be provided with the following EDMS features: a central shared area for storing documents; automatic indexing; document check-in/check-out; automatic versioning of documents; and document status information including version, check-out status, and last modified date. In an analogous manner, a user may also be able to manage data-analysis templates in a document management system.

A user may also be permitted to edit data-analysis templates that are communicated to the word processor application. For example, a user may open a data-analysis template and modify its contents. A user may modify the text (for example the title and opening paragraph) and formatting (for example font size and styles) of the data-analysis template using the standard editing capabilities of the word processor application for standard templates. The user may modify the contents of the data-analysis parts container using an embodiment of the present invention. One possible embodiment of the present invention, which allowed a user to modify data-analysis parts, was illustrated in FIG. 5. Another embodiment of the present invention, which allows a user to modify-data analysis parts, is illustrated in FIG. 7, wherein a user may select a code block 710 and bring up a (“right-click”) menu 720 whereupon the user may perform editing actions on the code block including, but not limited to, the following: creating a new empty code block below the selected code block; deleting the selected code block; or editing the selected code block in an auxiliary application program (for example, “Matrix Studio”).

A user may be able to create entirely new data-analysis templates. For example, a user may open a copy of a data-analysis template and insert new data-analysis parts in addition to standard static text and formatting. FIG. 8 illustrates a copy 800 of data-analysis template, wherein the data-analysis parts container 810 displayed in the document is empty. In this illustrative example, the user may place the cursor at a location of choice within the displayed data-analysis parts container and bring up a menu 830, wherein the user may select to “Insert a New Code Block.” When creating a new data-analysis template, a user may be able to define the associated data-analysis processor. In another embodiment, the user may select the data-analysis processor from a list of installed data-analysis processors.

In another embodiment of the invention, the word processor application may work entirely in the background without interaction with a user. In an illustrative example, the user may employ a custom application to initiate a data analysis request yet never see the word processor application. In such an embodiment, the custom application may employ the following method: select a data-analysis template; open the data-analysis template in the word processor application; include at least one data-analysis part in the data-analysis parts container by insertion or modification; communicate the data-analysis parts container to the data-analysis processor for generation of the data-analysis results collection; generate the data-analysis document comprising information from the data-analysis template and information from the data-analysis results collection; and return a word processor file to the user. The word processor application may work entirely in memory and processor of the computer and there may be no visual indication to the user that a word processor application was involved with communicating the document. In another embodiment, the word processor application may be replaced by a system capable of reading, writing and manipulating word processor documents but lacking a user interface. Said background operation may occur on a local machine or on a remote machine.

Although the forgoing text sets forth a detailed description of numerous different embodiments, it should be understood that the scope of the patent is defined by the words in the claims set forth at the end of the patent. The detailed description is to be construed as exemplary only and does not describe every possible embodiment because describing every possible embodiment would be impractical, if not impossible. Numerous alternative embodiments could be implemented, using either current technology or technology developed after filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and not limiting upon the scope of the claims.

What is claimed is:

1. A computer-implemented method for generating a data-analysis results document in a word processor application, the method comprising:
providing a data-analysis template, wherein the data-analysis template comprises a word processor document and a data-analysis parts container;
including at least one data-analysis part in the data-analysis parts container;
communicating the data-analysis parts container to a data-analysis processor for generating a data-analysis results collection using the at least one data-analysis part; and
generating a data-analysis results document.

2. The computer-implemented method of claim 1, wherein the word processor document comprises a computer-readable data structure wherein presentation content and data content may be separated.

3. The computer-implemented method of claim 1, wherein the word processor document comprises a Microsoft Word document.

4. The computer-implemented method of claim 1, wherein the data-analysis parts container comprises a computer-readable extensible markup language data structure.

5. The computer-implemented method of claim 1, wherein the at least one data-analysis part is selected from a group of data-analysis part types comprising object, code block and expression.

6. The computer-implemented method of claim 1, wherein the data-analysis processor comprises at least one selected from a group, the group comprising: a language interpreter, a library of methods, and a runtime environment.

7. The computer-implemented method of claim 1, wherein the data-analysis processor is selected from a group comprising:
R processor developed by R-Project for Statistical Computing;
S-Plus™ processor developed by Insightful Corporation;
MATLAB™ processor developed by MathWorks Corporation;
Python processor developed by Python Software Foundation;
IronPython processor developed by Microsoft Corporation;
Perl processor developed by Perl Foundation;
SAS™ processor developed by SAS Institute Corporation;
Mathematica™ processor developed by Wolfram Research Corporation;
Octave processor developed by the University of Wisconsin;
F# processor developed by Microsoft Corporation;
Haskell processor developed by the Yale Haskell group; and
Ruby processor developed by Gardens Point.

8. The computer-implemented method of claim 1, wherein the data-analysis processor provider is selected from a group comprising: the local machine, a network server, and a web service.

9. The computer-implemented method of claim 1, wherein the data-analysis results document comprises a word processor document comprising information from the data-analysis template and information from the data-analysis results collection.

10. The computer-implemented method of claim 1, further comprising storing the data-analysis results document as an electronic document file.

11. The computer-implemented method of claim 10, wherein the electronic document file is stored in a file format selected from a group of file formats comprising:
portable document format (*.pdf);
XML paper specification format (*.xps);
binary Microsoft Word format (*.doc);
extensible markup language format (*.xml);
Microsoft Word document template format (*.dot);
single file web page format (*.mht, *.mhtml);
web page format (*.htm, *.html);
web page, filtered format (*.htm, *.html);
rich text format (*.rtf);
plain text format (*.txt);
Microsoft Word markup language format (*.docx);
Microsoft Word markup language macro-enabled document format (*.docm);
Microsoft Word markup language document template format (*.dotx);
Microsoft Word markup language macro-enabled document template format (*.dotm); and
LaTeX format (*.tex).

12. The computer-implemented method of claim 1, further comprising modifying the data-analysis results document.

13. The computer-implemented method of claim 1, further comprising editing the data-analysis template.

14. The computer-implemented method of claim 1, further comprising generating the data-analysis template.

15. The computer-implemented method of claim 1, further comprising managing the data-analysis template in an electronic document management system.

16. The computer-implemented method of claim 1, further comprising managing the data-analysis results document in an electronic document management system.

17. The computer-implemented method of claim 1, further comprising providing a word processor application that works internally and is not visible to the user.

18. A computer-readable medium having computer-readable information for performing a computer-implemented method for generating data-analysis results in a word processor application, the method comprising:
providing a data-analysis template, wherein the data-analysis template comprises a word processor document and a data-analysis parts container;
including at least one data-analysis part in the data-analysis parts container;
communicating the data-analysis parts container to a data-analysis processor for generating a data-analysis results collection using the at least one data-analysis part; and
generating a data-analysis results document.

19. The computer-readable medium of claim 18, wherein the word processor document comprises a computer-readable data structure wherein presentation content and data content may be separated.

20. The computer-readable medium of claim 18, wherein the word processor document comprises a Microsoft Word document.

21. The computer-readable medium of claim 18, wherein the data-analysis parts container comprises a computer-readable extensible markup language data structure.

22. The computer-readable medium of claim 18, wherein the at least one-data analysis part is selected from a group of data-analysis part types comprising object, code block and expression.

23. The computer-readable medium of claim 18, wherein the data-analysis processor comprises at least one selected from a group comprising: a language interpreter, a library of methods, and a runtime environment.

24. The computer-readable medium of claim 18, wherein the data-analysis processor is selected from a group comprising:
R processor developed by R-Project for Statistical Computing;
S-Plus™ processor developed by Insightful Corporation;
MATLAB™ processor developed by MathWorks Corporation;
Python processor developed by Python Software Foundation;
IronPython processor developed by Microsoft Corporation;
Perl processor developed by Perl Foundation;
SAS™ processor developed by SAS Institute Corporation;
Mathematica™ processor developed by Wolfram Research Corporation;
Octave processor developed by the University of Wisconsin;
F# processor developed by Microsoft Corporation;
Haskell processor developed by several organizations; and
Ruby processor developed by RubyNET.

25. The computer-readable medium of claim 18, wherein the data-analysis processor provider is selected from a group comprising: the local machine, a network server, and a web service.

26. The computer-readable medium of claim 18, wherein the data-analysis results document comprises a word processor document comprising information from the data-analysis template and information from the data-analysis results collection.

27. The computer-readable medium of claim 18, further comprising storing the data-analysis results document as an electronic document file.

28. The computer-readable medium of claim 27, wherein the electronic document file is stored in a file format selected from a group of file formats comprising:
portable document format (*.pdf);
XML paper specification format (*.xps);
binary Microsoft Word format (*.doc);
extensible markup language format (*.xml);
Microsoft Word document template format (*.dot);
single file web page format (*.mht, *.mhtml);
web page format (*.htm, *.html);
web page, filtered format (*.htm, *.html);
rich text format (*.rtf);
plain text format (*.txt);
Microsoft Word markup language format (*.docx);
Microsoft Word markup language macro-enabled document format (*.docm);
Microsoft Word markup language document template format (*.dotx);
Microsoft Word markup language macro-enabled document template format (*.dotm); and
LaTeX format (*.tex).

29. The computer-readable medium of claim 18, further comprising modifying the data-analysis results document.

30. The computer-readable medium of claim 18, further comprising editing the data-analysis template.

31. The computer-readable medium of claim 18, further comprising generating the data-analysis template.

32. The computer-readable medium of claim 18, further comprising managing the data-analysis template in an electronic document management system.

33. The computer-readable medium of claim 18, further comprising managing the data-analysis results document in an electronic document management system.

34. The computer-readable medium of claim 18, further comprising providing a word processor application that works internally and is not visible to the user.

35. A computing apparatus for data analysis in a word processor application, the apparatus comprising:
a display unit that is capable of generating video images;
an input device;
a processing apparatus operatively coupled to said display unit and said input device, said processing apparatus comprising a processor and a memory operatively coupled to said processor;
a network interface connected to a network and to the processing apparatus;
said processing apparatus being programmed to allow providing a data-analysis template, wherein the data-analysis template comprises a word processor document and a data-analysis parts container;
said processing apparatus being programmed to allow including at least one data-analysis part in the data-analysis parts container;
said processing apparatus being programmed to allow communicating the data-analysis parts container to a data-analysis processor for generating a data-analysis results collection using the at least one data-analysis part; and
said processing apparatus being programmed to allow generating a data-analysis results document.

36. The computing apparatus of claim 35, wherein the word processor document comprises a computer-readable data structure wherein presentation content and data content may be separated.

37. The computing apparatus of claim 35, wherein the word processor document comprises a Microsoft Word document.

38. The computing apparatus of claim 35, wherein the data-analysis part container comprises a computer-readable extensible markup language data structure.

39. The computing apparatus of claim 35, wherein the at least one data-analysis part is selected from a group of data-analysis part types comprising object, code block and expression.

40. The computing apparatus of claim 35, wherein the data-analysis processor comprises at least one selected from a group comprising: a language interpreter, a library of methods, and a runtime environment.

41. The computing apparatus of claim 35, wherein the data-analysis processor is selected from a group comprising:
R processor developed by R-Project for Statistical Computing;
S-Plus™ processor developed by Insightful Corporation;
MATLAB™ processor developed by MathWorks Corporation;
Python processor developed by Python Software Foundation;
IronPython processor developed by Microsoft Corporation;
Perl processor developed by Perl Foundation;
SAS™ processor developed by SAS Institute Corporation;
Mathematica™ processor developed by Wolfram Research Corporation;
Octave processor developed by the University of Wisconsin;
F# processor developed by Microsoft Corporation;
Haskell processor developed by the Yale Haskell group; and
Ruby processor developed by Gardens Point.

42. The computing apparatus of claim 35, wherein the data-analysis processor provider is selected from a group comprising: the local machine, a network server, and a web service.

43. The computing apparatus of claim 35, wherein the data-analysis results document comprises a word processor document comprising information from the data-analysis template and information from the data-analysis results collection.

44. The computing apparatus of claim 35, further comprising a word processor application that works internally and is not visible to the user.
